(19) United States
(12) Patent Application Publication
(10) Pub. No.: US 2006/0162675 A1
(43) Pub. Date: Jul. 27, 2006

(54) Pet walking device

(76) Inventors: Mehrtosh A. Ghalebi, Rancho Santa Margarita, CA (US); Mehdi Hatamian, Coto De Caza, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/263,595

(22) Filed: Oct. 31, 2005

Related U.S. Application Data
(60) Provisional application No. 60/705,292, filed on Aug. 3, 2005.
(60) Provisional application No. 60/623,209, filed on Oct. 29, 2004.

(51) Int. Cl. A01K 27/00

(52) U.S. Cl. 119/796

(57) ABSTRACT

An improved pet walking device with their systems and methods are disclosed herein. More particularly, a pet walking device is disclosed with a detachable or built in flashlight, an attachable pet waste sack holder, a dynamo for recharging a flashlight, and an improved gear system to be used in connection with a retractable leash.

### CROSS-REFERENCE TO RELATED APPLICATION

This application claims the benefit of U.S. Provisional Application No. 60/705,292, filed Aug. 3, 2005, and U.S. Provisional Application No. 60/623,209, filed Oct. 29, 2004, the entireties of which are hereby incorporated by reference.

### SUMMARY OF THE INVENTION

The inventions disclosed herein relate to devices for use while walking pets. In some embodiments, a convenient hand-held device is provided with a flashlight, a pet waste sack receptacle, and a retractable pet leash.

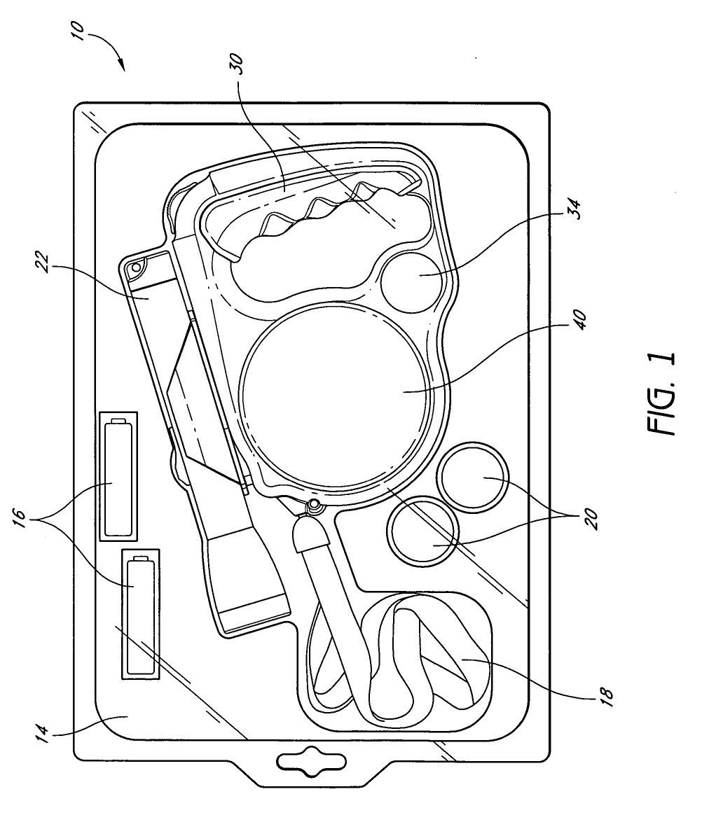

FIG. 1 illustrates a pet walking device 10 as it appears prepared for sale. In some embodiments, the device 10 is encased in plastic packaging 14 having various molded depressions for the components sold with the pet walking device 10. For example, two batteries 16 are included in the plastic packaging 14. Other components sold with the device can be, for example, a leash strap 18, two replacement pet waste sack holders 20, and a flashlight 22. The pet walking device 10 has a handle 30, a pet waste sack holder 34, and a retractable leash coil holder 40. This description illustrates only one possible method of packaging the invention; there are many different methods of packaging the device which would be apparent to those skilled in the art.

In some embodiments, the pet walking device may be manufactured and sold in different sizes, for example, an adult size, a child size, a large pet size, or a small pet size. In some embodiments, the pet walking device may be manufactured and sold in different colors including, for instance, multiple combinations of colors on the same pet walking device. The pet walking device may also be manufactured to be all the same color.

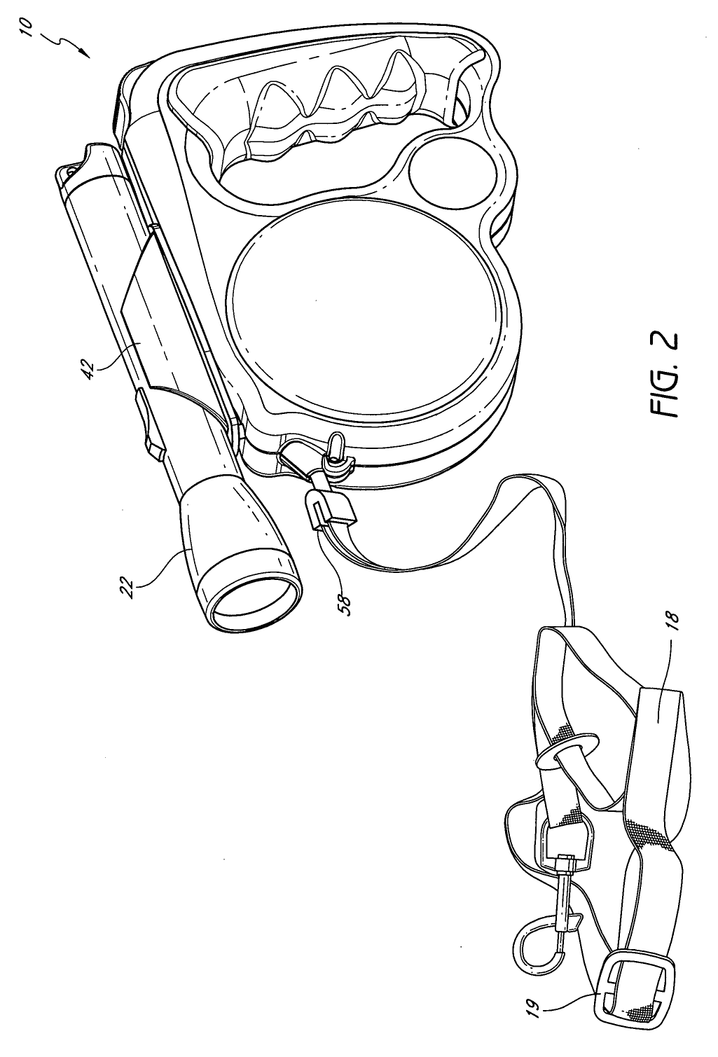

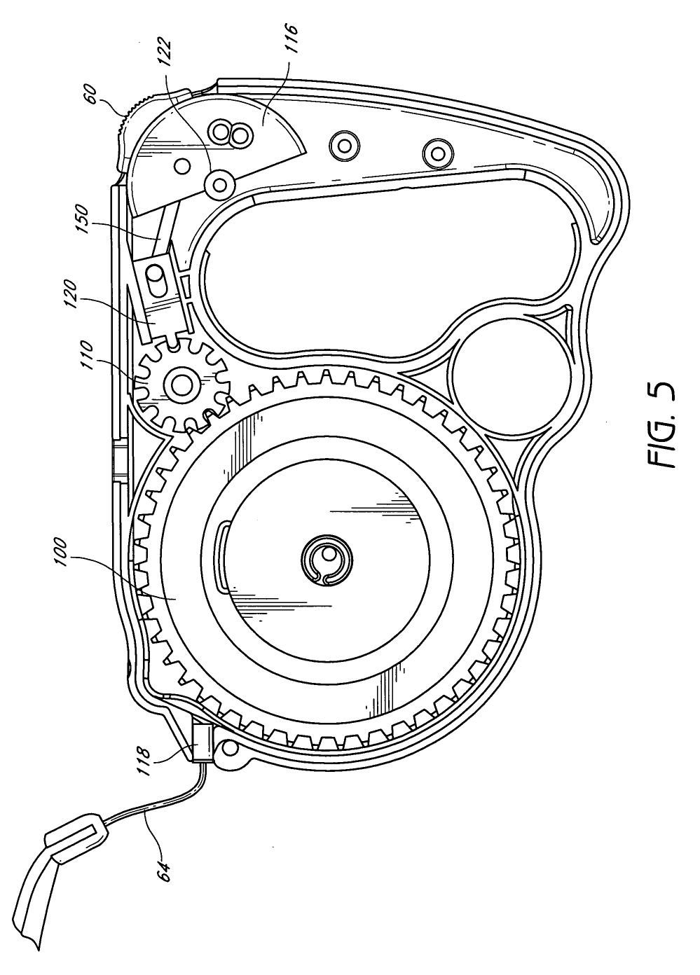

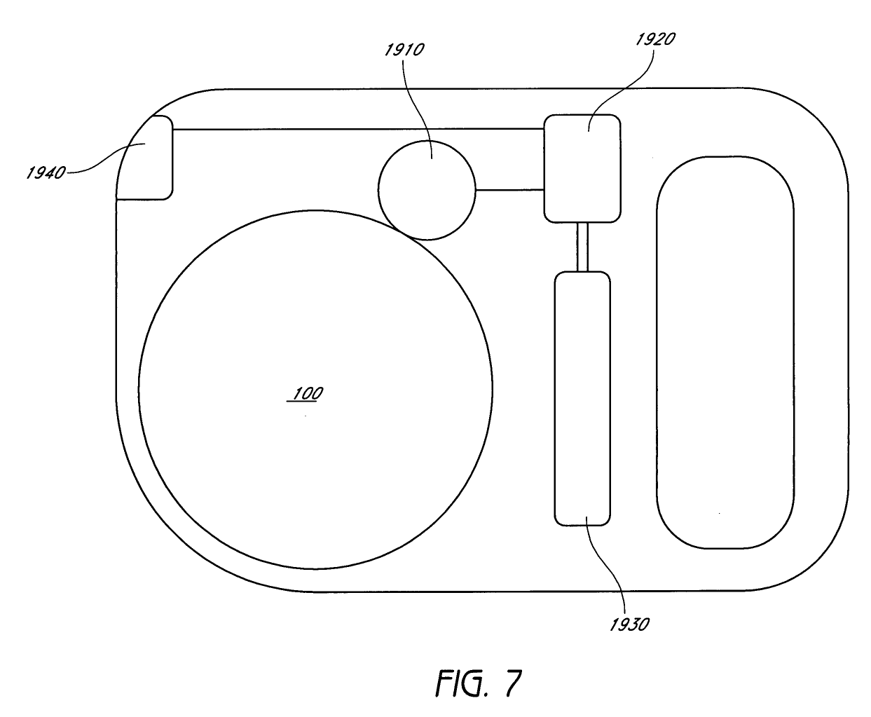

FIG. 2 shows another view of the pet walking device 10. In some embodiments, the flashlight 22 is attached to the pet walking device 10 by a flashlight holder 42. A leash strap 18 has a strap slider 19 through which the leash strap 18 is threaded. Leash strap 18 is connected to strap clamp 58, which in turn is connected to leash string 64 see FIG. 5. The flashlight holder 42 holds the flashlight 22 generally pointing in the direction of the leash strap 18, to allow the flashlight 22 to illuminate the general area where the pet will be located. The flashlight 22 can be detachable from the pet walking device or it can be permanently attached to the pet walking device. A light can also be included within the main casing of the device as described with respect to FIG. 7, for example.

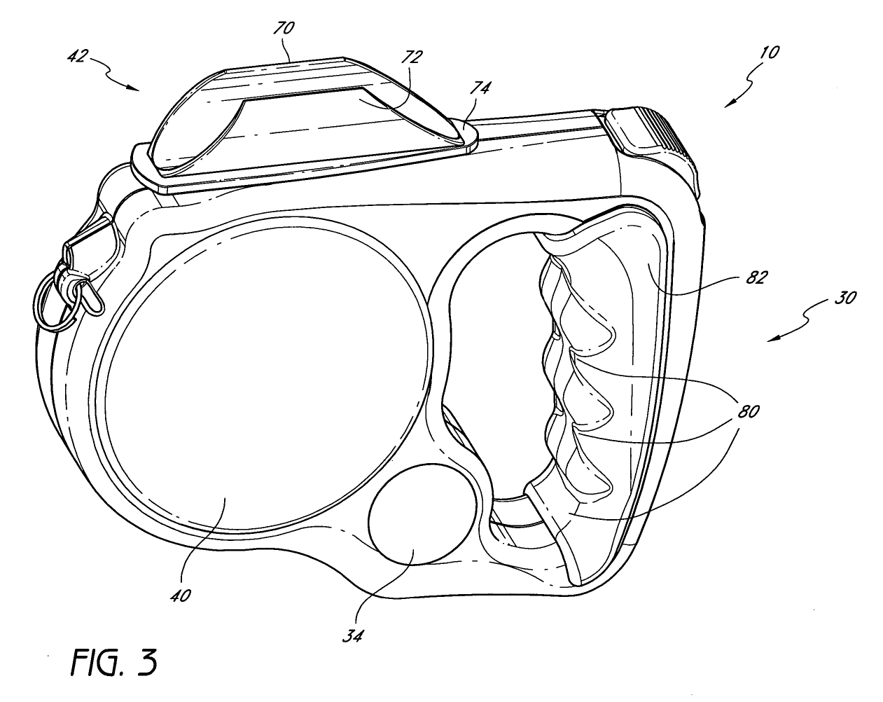

FIG. 3 illustrates the pet walking device 10 with flashlight 22 removed from flashlight holder 42. In some embodiments, grip cushion 82 with finger grooves 80 is connected to handle 30. The finger grooves 80 can be designed to accommodate the fingers of a user holding the pet walking device 10 in the user's grip. However, some embodiments may have a grip cushion 82 without finger grooves 80. Some embodiments may include integrally molded finger grooves. Some embodiments may also contain an integrally molded handle with out finger grooves.

Also illustrated are three portions of flashlight holder 42. In some embodiments, left flange 70 protrudes upwardly from pet walking device 10 and right flange 72 also protrudes generally upwardly from pet walking device 10. The two flanges partially surround flashlight 22 when it is in place. Base 74 supports left flange 70 and right flange 72. The three pieces can be molded from plastic to form an integrated whole, or may be made from several different sections which are connected together.

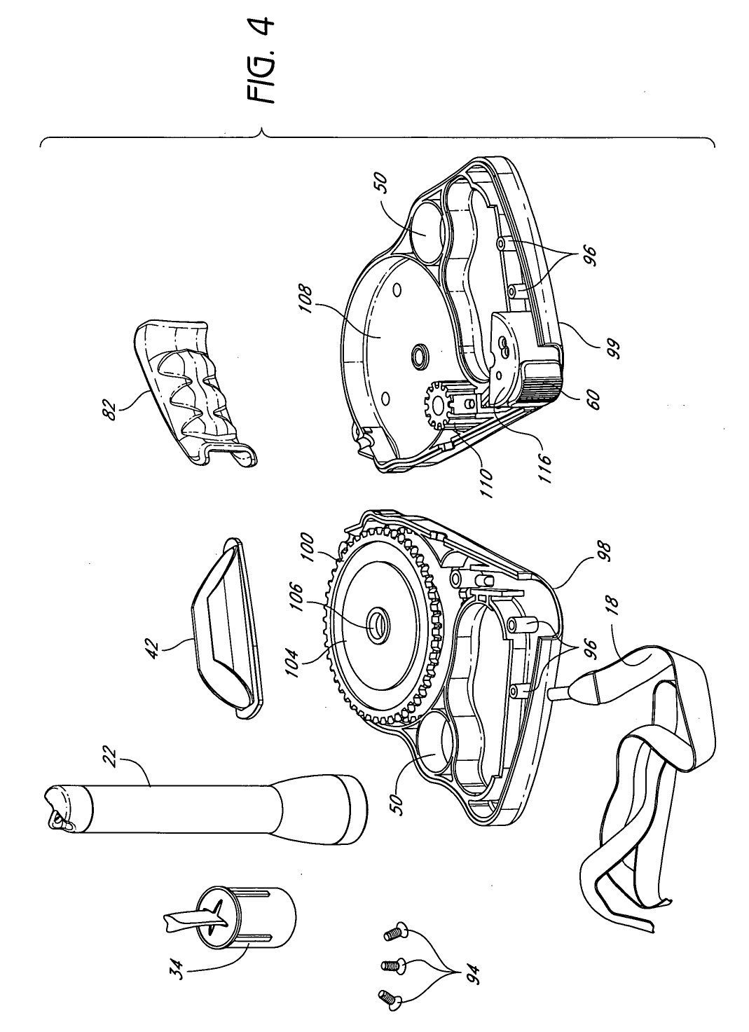

FIG. 4 illustrates the walking device partially disassembled. Shown in this illustration are pet waste sack holder 34, flashlight 22, flashlight holder 42, grip cushion 82, leash strap 18, and thumb switch 60. In this figure, the two molded plastic halves, 98 and 99, of the pet walking device 10 have been separated. This is accomplished in some embodiments by removing screws 94 from screw tubes 96. Screw tubes in the two cooperating molded plastic halves, 98 and 99, of the pet walking device 10 join together when the molded plastic halves, 98 and 99, are fastened together. Screws 94 can then be fastened into screw tubes 96 to hold the device together. There are many different methods of connecting the two molded plastic halves, 98 and 99. For instance, glue, or integrally molded clips may be used to connect the two halves. Other methods of connecting the halves may also be used.

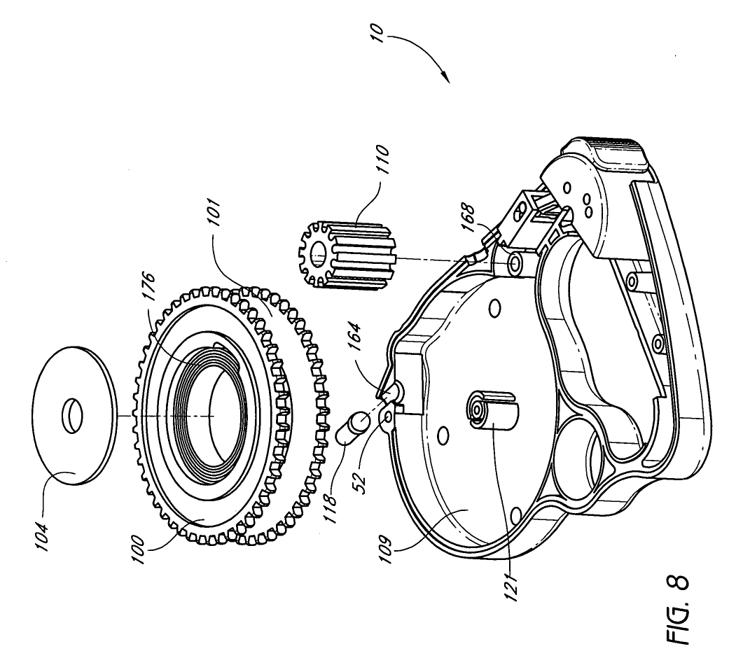

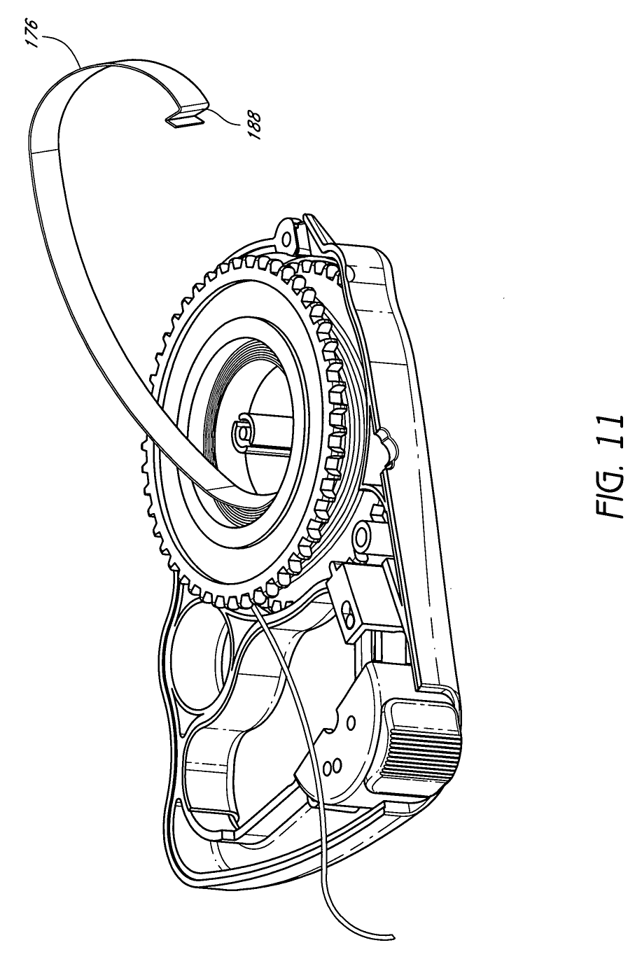

Also shown in FIG. 4 is leash wheel 100, having a spring lid 104 and a central screw 106. According to some embodiments, the right half of the plastic portion of the pet walking device 10 has a leash wheel casing 108, and a control wheel 110, as well as a switch body 116. The leash wheel 100 has the leash string 64 wrapped around its inner shaft 101, see FIG. 8. Underneath spring lid 104 is a spring 176, see FIG. 11, that urges the leash wheel 100 to spin, thereby retracting the leash string 64 and leash strap 18 when the leash string 64 and leash strap 18 have been extended. Leash wheel casing 108 provides a depression within which leash wheel 100 can freely spin, even when the two molded plastic halves of the pet walking device 10 are screwed together. Control wheel 110 fits into leash wheel 100 to enable the user to stop the leash wheel 100 from turning through use of the switch body 116 and thumb switch 60. In some embodiments, for instance in the embodiment illustrated in FIG. 4, holding ring 50 has two cooperating halves, one in each half of the two plastic halves, 98 and 99, of the pet walking device.

The leash wheel casing 108 and other portions of the plastic casing of the dog walking device can be made from a polyolephins such as Acrylonitrile Butadiene Styrene (ABS). The internal components such as the leash wheel 100 can also be made from ABS. In some embodiments, the mechanical components such as the leash wheel 108 and control wheel 110 can be made from polycarbonates. In some embodiments, the outer casing of the pet walking device 10 is formed from ABS, which can allow a chrome plating to adhere to it.

FIG. 5 demonstrates the thumb switch 60 in the up position. In some embodiments this allows leash string 64 to remain outside of retractable leash coil holder 40 even when a pet is not pulling on the leash. The leash string 64 in some embodiments is threaded through a leash string sleeve 118. Leash string 64 may be of any suitable length and may be made out of any suitable material. FIG. 5 illustrates the leash string 64 partially extended.

As this figure illustrates, in some embodiments, control wheel 110 has cogs that fit into corresponding grooves on leash wheel 100. Similarly, a wheel stopper 120 can fit into an inter-cog groove on control wheel 110. In some embodiments, switch 60 is integrally molded to switch body 166. Switch body 116 is connected to switch arm 150 which is connected to wheel stopper 120. There is also a crescent-shaped groove 122, in some embodiments, on switch body 116 to facilitate the circular motion of the switch body 116. Thumb switch 60 is in the up position in this figure, causing the switch arm 150 to push wheel stopper 120 which engages the control wheel 110 which in turn engages the leash wheel 100, and disables the retraction feature.

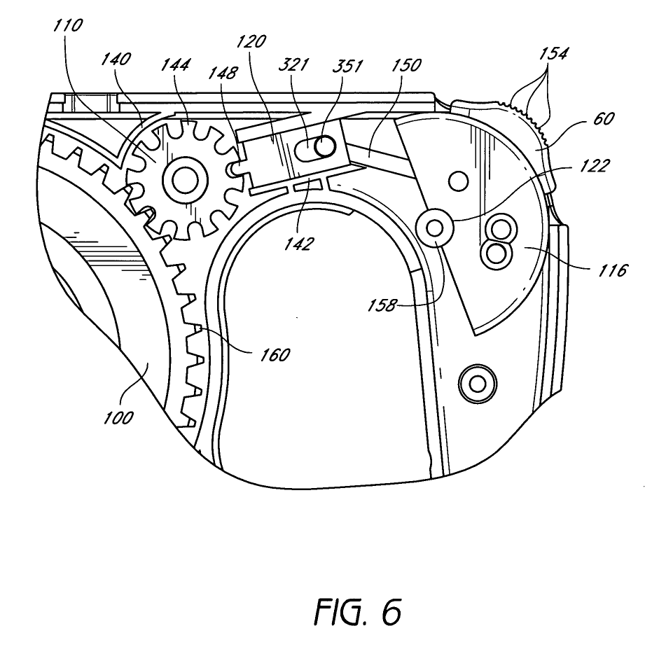

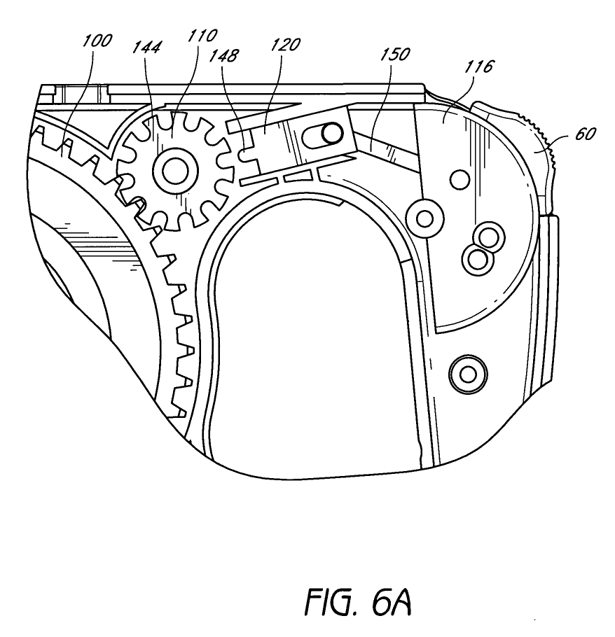

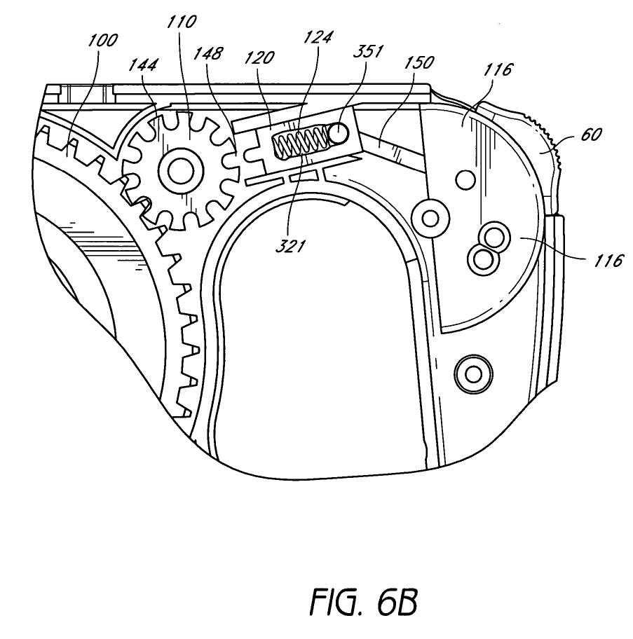

FIG. 6 shows a close-up view of this mechanism. In this figure, leash wheel 100 has multiple cogs 160. In some embodiments, cogs 160 engage with counterpart cogs 144 on the control wheel 110. In some embodiments, leash wheel 100 and control wheel 110 are both held in place by molded ridges, such as molded ridge 140. The molded ridges are part of the plastic molded outer structure of the pet walking device 10. In some embodiments, similar molded ridges hold other components in place, such as the wheel stopper 120, which is held in place by molded ridge 142. Protrusion 148 on wheel stopper 120 fits in-between cogs 144 on control wheel 110. Wheel stopper 120 is advanced into position with control wheel 110 by switch arm 150, which articulates with wheel stopper 120. At its other end, switch arm 150 can also articulates with switch body 116. Thumb switch 60 can be integrally formed with switch body 116. In some embodiments, thumb switch 60 has on its outer surface traction ridges 154, to provide traction for a user attempting to move thumb switch 60. In some embodiments, switch body 116 is held in place by molded rod structure 158. Molded rod structure 158 performs a similar retaining role to that role played by molded ridge 142 and molded ridge 140. In some embodiments, molded rod structure 158 is integrally formed with the molded plastic structure of the plastic casing of pet walking device 10. Specifically, molded rod structure 158 fits into and abuts groove 122 in switch body 116. In some embodiments, switch body 116 forms approximately half of a toroidal shape, and slidingly rotates around molded rod structure 158 when thumb switch 60 moves between the up position and the down position. In some embodiments, a slot 321 can be formed within wheel stopper 120. This slot 321 allows switch arm 150 and wheel stopper 120 to be non-rigidly coupled. In particular, slot 321 provides a structure along which switch arm head 351 can slide. The sliding movement of switch arm head 351 is along the same axis as the sliding movement of wheel stopper 120.

In some embodiments, the cogs 144 have rounded outer surfaces so as to facilitate wheel stopper 120 to slide in between cogs 144 and stop control wheel 110. When the cogs 144 have flat or squared outer surfaces, the protrusion 148 will be less likely to slide in between cogs 144 then when cogs 144 have rounded outer surfaces. For example, if an operator of pet walking device desires to stop the advance of the pet, the operator slides the thumb switch 60 to the up position. This, in turn, urges wheel stopper 120 forward toward control wheel 110. However, if protrusion 148 encounters a flat or squared cog 144 directly, hitting the cog squarely on its tip instead of sliding into a space between two cogs, advance of wheel stopper 120 is temporarily halted. In some embodiments where the cogs 144 have rounded outer surfaces, when the wheel stopper 120 is urged forward, protrusion 148 will be more likely to slide into a space between the cogs because there is less flat surface area at the end of the cogs to stop the advance of wheel stopper 120. In addition, even when the protrusion 148 encounters an edge of a rounded cog 144, because the cogs 144 have been rounded, protrusion 148 will be more likely to slide along the rounded edge of the cog into a space between the cogs instead of the advance being halted by a flat or squared cog surface. Thus, a rounded cog will facilitate an operator's ability to stop the release of leash string 64 and thus stop the distance between a pet and the leash operator.

One method of using the illustrated mechanism is described as follows: a pet owner is walking a pet who tugs at the leash strap surrounding its neck. The leash strap is connected to the strap clamp 58, which is also connected to leash string 64. Leash string 64 is wrapped around leash wheel 100, but when the pet tugs at the leash strap 18 and leash string 64, leash string 64 is unwound from leash wheel 100 and slides through leash string sleeve 118 as it approaches a fully extended position. When leash string is fully extended, the pet is approximately 18 feet from the pet walking device 10, which is gripped by the pet walker. As leash string 64 unwinds and extends, leash wheel 100 spins to release leash string 64.

However, if the pet walker who is using the pet walking device 10 desires to halt the advance of the pet, thumb switch 60 may be employed to halt the spinning of leash wheel 100. The pet walker pushes upwards on traction ridges 154 on thumb switch 60. This causes switch body 116 to rotate upwardly and inwardly around molded rod structure 158. Switch body 116 pushes as it rotates on switch arm 150 which in turn pushes wheel stopper 120 forward in-between molded ridges, such as molded ridge 142. As wheel stopper 120 advances, protrusion 148 fits in-between cogs 144 on control wheel 110. Because wheel stopper 120 is held in place by molded ridges 140, control wheel 110 is abruptly stopped in its rotation by protrusion 148. Because cogs 144 are interconnected with cogs 160, the rotation of leash wheel 100 is also stopped and the leash string 64 can no longer continue extending.

In some embodiments, the device is designed to keep the leash wheel 100 from retracting the leash too quickly, while still allowing leash wheel 100 to spin. For example, if a pet on the leash comes bounding back toward its owner so rapidly that the leash wheel is allowed to spin freely with no resistance from the retracting leash, the leash string 64 may not wind smoothly onto leash wheel 100. To avoid this potential dilemma, the relationship between the sizes of leash wheel 100 and control wheel 110 can be advantageously calculated to provide appropriate control of the leash wheel 100. Because of the mechanical relationship between leash wheel 100 and control wheel 110, the two wheels roll along each others' surfaces without slipping. Cogs 144 and 160 insure that no slipping will occur as the two wheels rotate. However, because leash wheel 100 is larger than control wheel 110, leash wheel 100 makes only one complete revolution during the same time that control wheel 110 makes more than one complete revolution. Thus, control wheel 110 must turn more quickly than leash wheel 100 because of their relative sizes. However, the two wheels are subject to similar frictional forces. The wheels touch the molded plastic components around them as they spin, and the physical contact between components is accompanied by frictional forces that resist relative movement of the touching components. These frictional forces are similar for the two wheels, because the two wheels are made from the same or similar materials, and the two wheels are housed in and contacting similar materials as they turn. However, the smaller control wheel 110 adds more friction to the mechanically coupled system than would exist without the extra wheel, thus adding additional resistive force and potentially reigning in a runaway leash wheel 100. Furthermore, the faster rotation of the smaller control wheel 110 about its axis does more work against the resistive frictional forces, potentially dissipating more energy than even the leash wheel 100 over the same time period. Thus, the control wheel 110 can act to control the rapid spinning of the leash wheel 100, even without wheel stopper 120.

Another physical mechanism can also contribute to the control function of the control wheel 110. Any torque exerted on control wheel 110 by leash wheel 100 is also exerted, in an equal and opposite manner, on leash wheel 100 by control wheel 110. Thus, control wheel 110 resists acceleration of the leash wheel 100. Indeed, the greater the acceleration of leash wheel 100, the greater the resistance to that acceleration by control wheel 110. A combination of the consequences of Newton's laws of motion and frictional effects allow a control wheel such as control wheel 110 to perform its control function.

FIG. 6A illustrates the same features described above. In particular, protrusion 148 can be seen. Thumb switch 60 is in the down position in this figure, and wheel stopper 120 is not engaged with the cogs 144 on control wheel 110.

FIG. 6B illustrates some embodiments in which a spring 124 is also located inside wheel stopper 120 and is configured to push switch arm head 351 toward the end of the slot 321 farthest from control wheel 110. Similarly, when thumb switch 60 is pushed upward and switch arm 150 is pushed forward in slot 321, the spring inside wheel stopper 120 urges wheel stopper 120 into contact with control wheel 110. The spring can help the protrusion 148 on wheel stopper 120 experience continuing force, thus increasing the likelihood that wheel stopper will move into place between cogs 144 when thumb switch 60 is pushed upwardly. For example, if an operator of pet walking device desires to stop the advance of the pet, the operator pushes upward on thumb switch 60. This, in turn, urges wheel stopper 120 forward toward control wheel 110. However, if protrusion 148 encounters a cog 144 directly, hitting the cog squarely on its tip instead of sliding into a space between two cogs, advance of wheel stopper 120 is temporarily halted. If there were no spring inside wheel stopper 120, and if switch arm head 351 were not allowed to slide inside slot 321, the operator may have to attempt to slide thumb switch 60 up multiple times. On a repeat try, the protrusion 148 may happen to fit in between cogs 144 instead of hitting a cog directly, but this may not occur in a predictable manner. However, in the illustrated embodiment, the spring and slot 321 allows the operator to apply constant upward pressure, and as soon as an opening between cogs 144 is appropriately positioned, protrusion 148 is urged forward the rest of the way by the force of the spring. Such a configuration allows greater ease of use and convenience to a pet walker because operation of thumb switch 60 is more predictable and consistent, as well as being less jarring on the user.

FIG. 7 schematically depicts a pet walking device. In some embodiments, the energy transferred to the control wheel 110 as it slows down the leash wheel 100 can be converted into electrical energy through a dynamo 1910 that generates power and stores it in batteries such a battery 1930. As used in this specification, the term “dynamo” can refer to any device that generates electricity. For example, a dynamo can generate electricity by causing a magnet to spin against a resistive force. A dynamo can generate energy in a way similar to an automobile alternator charges an automobile battery, for example. The dynamo 1910 can take the place of or be incorporated into the control wheel and interface with the leash wheel 100. The dynamo can be connected through a controller 1920 to a battery 1930. The controller 1920 can comprise an electrical circuit, for example. The dynamo 1910 and/or the controller 1920 and/or the battery 1930 can be connected to and provide power to illuminate a light 1940, which can be an incandescent bulb or a light-emitting diode (LED), for example. One application of a dynamo 1910 can be to power a light 1940 that is located inside the main portion of the plastic casing of the pet walking device 10, thus eliminating the peripheral flashlight 22 and the flashlight holder 42. In some embodiments, the dynamo may be used to charge a flashlight containing a battery which can be electrically as well as physically connectable to the pet walking device 10. In some embodiments, the controller can allow the dynamo to generate electricity no matter which direction the leash wheel 100 is turning. The controller can control the flow of electricity between the dynamo 1910, the battery 1930, and the light 1940. The controller can provide thresholds and routing logic, for example.

The energy converted to electricity by a dynamo 1910 can originate in a person using the device and/or in the pet. As the user and the pet draw farther apart, as the pet runs ahead of the user, for example, the leash string 64 unwinds from and spins the leash wheel 100, creating tension in the spring 176, which stores energy. When the tension in the leash string 64 is lessened, for instance, when the pet draws nearer to the user, the spring 176 releases energy and rotates the leash wheel 100, winding the leash string 64 onto the leash wheel 100. However, if the pet and user come together quickly so that there is effectively no tension on the leash string 64, the spring 176 can have more energy than needed to wind the leash string 64 back on to the leash wheel 100. In this case, some of the extra energy stored in the spring 176 is transferred to the control wheel 110, which can be mechanically linked to the dynamo 1910. In some embodiments, the control wheel 110 can comprise the dynamo. The dynamo 1910 can provide a degree of rotational resistance against the spinning leash wheel 100, or the spinning control wheel 110. At least some of the energy that counteracts and generally overcomes this resistance is converted into electricity. Thus, the dynamo 1910 converts rotational energy into electricity and sends the electricity to be stored in the battery 1930 such as a nickel metal hydride or a nickel cadmium battery. In some embodiments, the dynamo 1910 can send electricity to the light 1940 without the electricity passing through the battery 1930. The dynamo 1910 can also generate electricity when a pet is surging ahead of the person walking the pet and forcefully unwinding the leash string 64, providing excess energy and forcing the dynamo 1910 to rotate even while the spring 176 winds.

In some embodiments, the control wheel 110 or dynamo 1910 can reduce the likelihood that the leash clip 54 or similar parts will retract too quickly and strike a user or a passer-by. The above mechanisms can all contribute to the effect of slowing down leash retraction. In some embodiments, the frictional and torque-related mechanisms can combine with an electricity-generating dynamo to make a device more safe, diminishing or eliminating the risk of potential whip-lash or dangerously rapid retraction of the leash.

FIG. 8 shows another view of the partially disassembled pet walking device 10. In this figure, leash string sleeve 118 is not located within groove 164. Furthermore, control wheel 110 has been removed, revealing molded rod structure 168. Control wheel 110 slides down and surrounds molded rod structure 168 when the pet walking device 10 is fully assembled. In some embodiments, screw holder 52 is located next to groove 164. Screw holder 52 receives a screw that holds the two sides of the plastic molded casing together when the pet walking device 10 is fully assembled. Spring holder 121 protrudes from one half of the plastic molded casing of pet walking device 10. Spring holder 121 is similar in some ways to molded rod structure 168, because it can be integrally molded with the plastic casing. However, as will be seen in other figures, spring holder 121 has special structures designed to hold a spring. Spring holder 121 is located in the center of leash wheel casing 109 and extends through the center of leash wheel 100 when the pet walking device is fully assembled. The central structure in spring holder 121 receives central screw 106 when the device is fully assembled. Also shown are spring lid 104 and spring 176 coiled inside leash wheel 100.

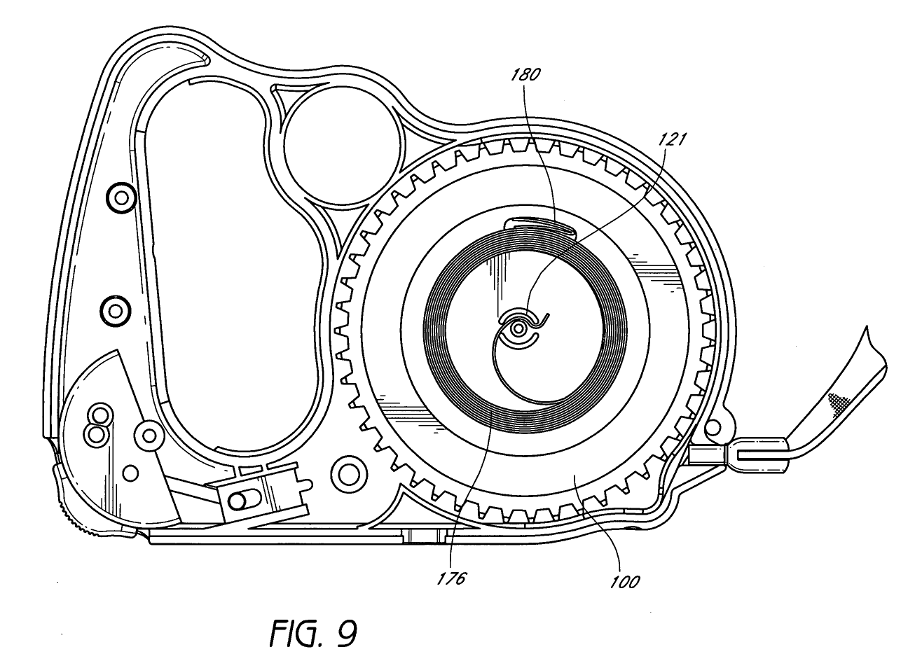

FIG. 9 shows spring 176 coiled within leash wheel 100 and attached to leash wheel 100 at spring clasp 180. The other end of the long ribbon-like metal spring is threaded through the features of spring holder 121.

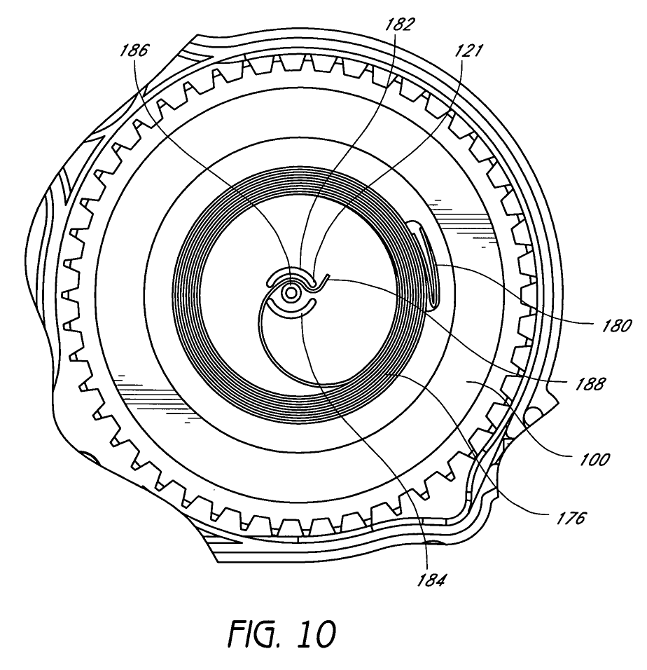

FIG. 10 shows a close-up view of the spring 176 coiled within the leash wheel 100. Spring holder 121 comprises arc portion 182, arc portion 184, and central portion 186. Spring tip 188 is bent so as to penetrate between arc portion 184 and central portion 186. Also shown in this illustration is spring clasp 180. This configuration holds spring tip 188 in place. Because spring 176 is formed from a thin ribbon-like sheet of resilient metal, as leash wheel 100 rotates in the clockwise direction, spring 176 is wrapped more tightly around spring holder 121. This creates tension in the spring and urges the leash wheel 100 in the opposite, or counter clockwise direction. Other methods of holding the spring 176 in place may also be used.

FIG. 11 illustrates spring 176 protruding and partially uncoiled. Also visible is spring tip 188 which is bent as described above. In some embodiments, spring tip 188 may not be bent if other holding means are used for spring 176.

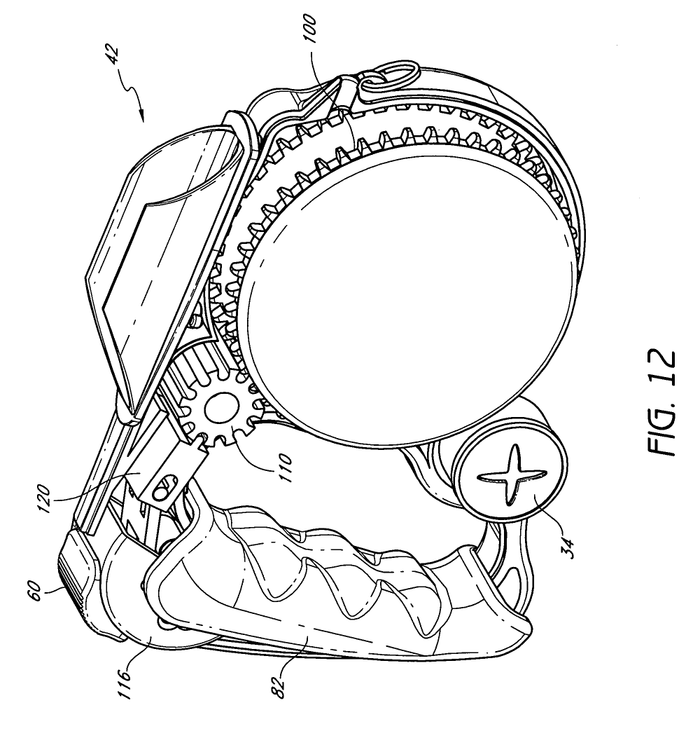

FIG. 12 illustrates a cutaway view of the pet-walking device, revealing the leash wheel 100 and the control wheel 110 inside. Also shown are waste sack holder 34, grip cushion 82, switch body 116, thumb switch 60, wheel stopper 120, and flashlight holder 42.

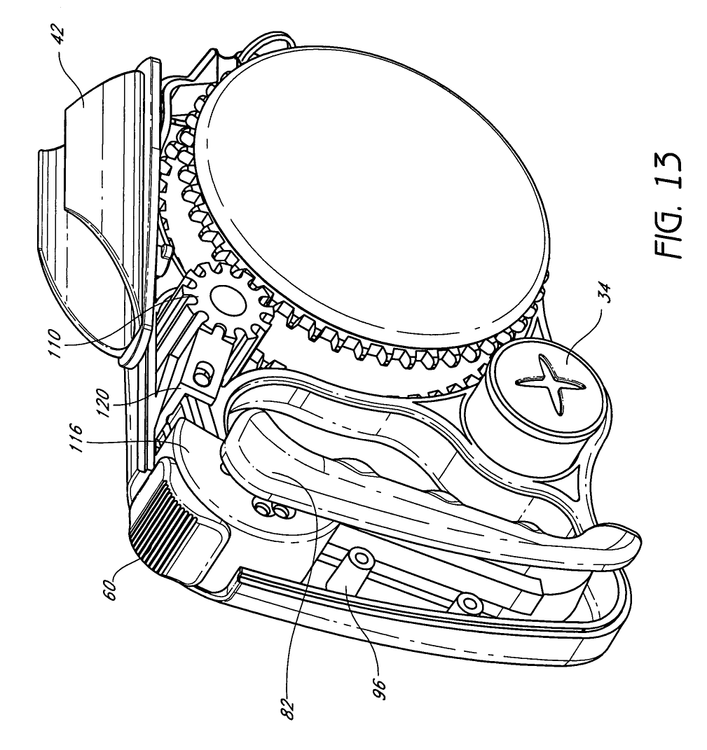

FIG. 13 illustrates another perspective of the cut-away view of the pet walking device, including a view of screw tube 96.

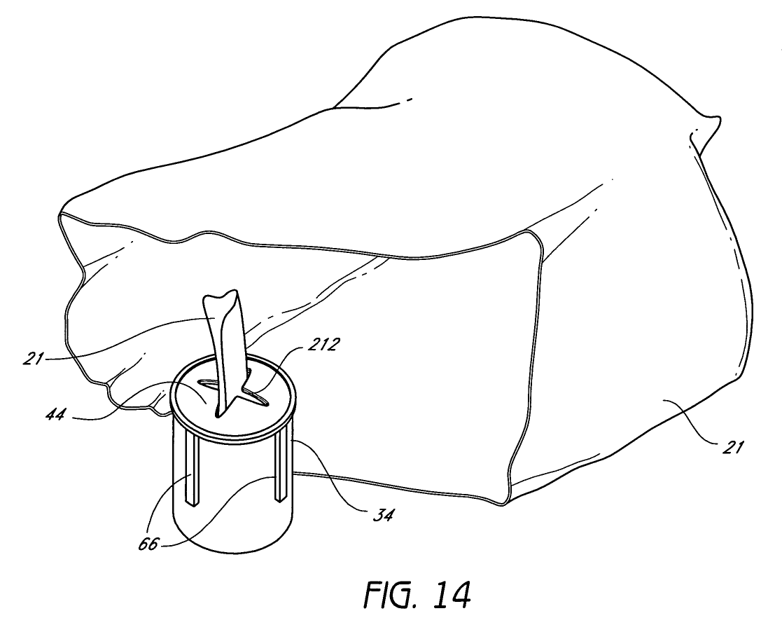

FIG. 14 illustrates a close-up view of the pet waste sack holder 34. In some embodiments the top of the pet waste sack holder 34 may comprise a selectively restrictive opening 44. The opening allows pet waste sacks 21 to be individually pulled from the pet waste sack holder 34 while still retaining other pet waste sacks in pet waste sack holder 34 for future use. In some embodiments, the pet waste sacks are wound together in a continuous manner inside the generally cylindrical pet waste sack holders 34.

Also shown is pet waste sack 21 protruding from the selectively restrictive opening 44 of pet waste sack holder 34. Pet waste sack 21 is still partially coiled after having been pulled from a coil of multiple pet waste sacks 21 located within pet waste sacker holder 34. Opening 44, in conjunction with various points, such as point 212, allows pet waste sacks, such as pet waste sack 21, to be pulled from within pet waste sack holder 34. The points 212 provide a friction surface which clings to each pet waste sack as it is pulled from the sack holder 34. In this way, a roll of connected but separable pet waste sacks can release one sack at a time. As each pet waste sack is pulled from the sack holder 34, the points 212 surrounding the opening 44 protrude inwardly toward the sack and cling to the next sack in the sequence of connected sacks. In this way, one pet waste sack 21 can be pulled from the sack holder 34 while the pet waste sack 21 is separated from the next sack, leaving the next sack protruding slightly, but still largely within pet waste sack holder 34. Pet waste sack 21 is a lightweight plastic sack designed to contain pet waste while protecting the hand of a pet owner from contamination. Ridges 66 are visible on the outer surface of pet waste sack holder 34, which in some embodiments helps to hold pet waste sack holder 34 in place in pet walking device 10.

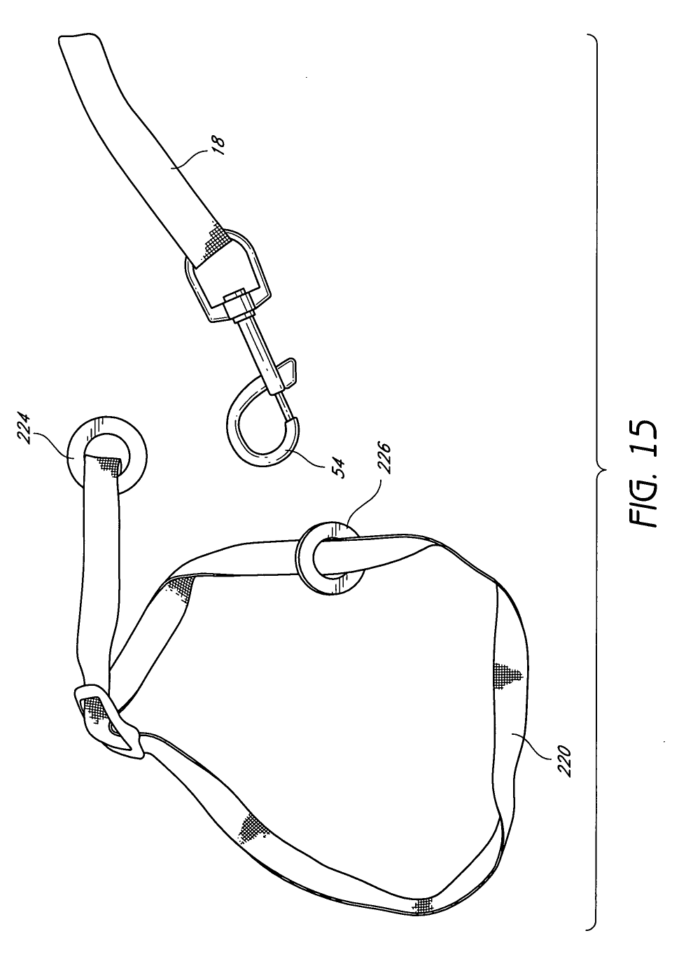

FIG. 15 shows a close-up view of leash strap 18, separated into two components. Leash clip 54 has been removed from strap ring 224 and strap ring 226 to allow collar strap 220 to separate from leash clip 54. When the leash clip 54 is linked to strap ring 224 and strap ring 226, collar strap 220 does not tighten down on the pet's neck when the pet strains forward, pulling at leash strap 18. The clips, rings, and straps, as described herein, can have other configurations as well understood by those of skill in the art.

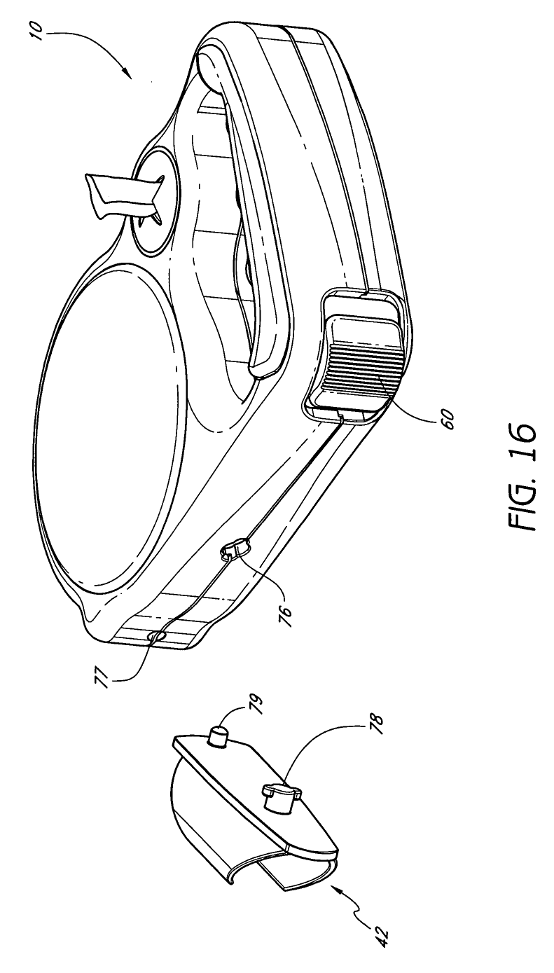

FIG. 16 shows flashlight holder 42 after it has been removed from pet walking device 10. In some embodiments, a hole 76 in the top of pet walking device 10 cooperates with a protrusion 78 when flashlight holder 42 is secured in place on pet walking device 10. Also illustrated are protrusion 79 which cooperates with hole 77 in the top of the pet walking device 10 to prevent flashlight holder 42 from twisting relative to the pet walking device 10. In this illustration, the protrusions 78 and 79 are no longer within their respective holes 76 and 77. There are various methods of connecting flashlight holder 42 to walking device 10. For instance, flashlight holder 42 could be integrally molded to pet walking device 10, or could be attached by screws or nails or any other known fastening means.

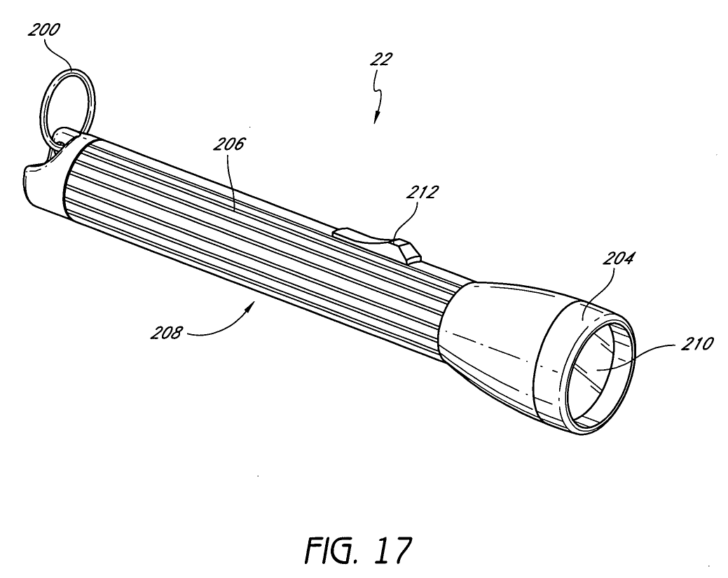

FIG. 17 shows flashlight 22. In some embodiments, ribbed finish 206 provides a gripping surface for flashlight handle 208. In some embodiments, ribbed finish 206 provides a gripping surface for flashlight holder 42. Flashlight ring 200 can be rotated away from the flashlight as shown to provide a handle, grip, or hanging feature. The flashlight has a window 210 through which light is emitted. The flashlight 22 also has a switch 212 that can be used to turn the flashlight on or off. Flashlights of all different sizes, colors, and shapes may be used with the present invention, as would be understood by those of skill in the art.

The foregoing description provides examples of certain embodiments of the inventions. Many variations in the disclosed structure and features will be apparent to those skilled in the art after reading this disclosure, and such variations are within the scope of the inventions in this application.

We claim:

1. A pet walking device comprising:
a handle;
a retractable string connectable to a leash; and
a light source connectable to the pet walking device.

2. The pet walking device of claim 1, further comprising a pet waste sack holder adapted to be connected to the pet walking device.

3. The pet walking device of claim 1, wherein the light source is electrically coupled to a dynamo for generating electrical power.

4. The pet walking device of claim 3, wherein the dynamo generates electrical power using the motion of the leash.

5. The pet walking device of claim 4, further comprising a coiling reel adapted to coil at least a portion of the leash within the device.

6. The pet walking device of claim 5, further comprising a retraction mechanism adapted to impart a torque to the coiling reel to retract the leash onto the coiling reel.

7. The pet walking device of claim 6, further comprising a dampening mechanism for slowing the retraction of the leash.

8. The pet walking device of claim 7, wherein the dynamo dampens the motion of the leash.

9. A pet walking device comprising:
a handle;
a retractable string connectable to a leash; and
a pet waste sack holder connectable to the pet walking device.

10. The pet walking device of claim 9, wherein the light source is electrically coupled to a dynamo for generating electrical power.

11. The pet walking device of claim 10, wherein the dynamo generates electrical power using the motion of the leash.

12. The pet walking device of claim 11, further comprising a coiling reel adapted to coil at least a portion of the leash within the device.

13. The pet walking device of claim 12, further comprising a retraction mechanism adapted to impart a torque to the coiling reel to retract the leash onto the coiling reel.

14. The pet walking device of claim 13, further comprising a dampening mechanism for slowing the retraction of the leash.

15. The pet walking device of claim 14, wherein the dynamo dampens the motion of the leash.

16. A pet walking device comprising:
a housing with a handle;
a leash retractable within the housing; and
a dynamo.
